(19) United States
(12) Patent Application Publication
(10) Pub. No.: US 2026/0148571 A1
(43) Pub. Date: May 28, 2026

(54) METHOD FOR AUTOMATING TARGET LABELING FOR PARKING SPACE RECOGNITION AND APPARATUS THEREFOR

(71) Applicants: Hyundai Motor Company, Seoul (KR); Kia Corporation, Seoul (KR)

(72) Inventors: Keun Ho CHOI, Hwaseong-Si (KR); Yang Shin Kim, Hwaseong-Si (KR); Deuk Hyeon Kim, Hwaseong-si (KR)

(73) Assignees: Hyundai Motor Company, Seoul (KR); Kia Corporation, Seoul (KR)

(21) Appl. No.: 19/229,900

(22) Filed: Jun. 5, 2025

(30) Foreign Application Priority Data
Nov. 27, 2024 (KR) 10-2024-0172703

(51) Int. Cl. G06V 20/58; G01C 21/00; G06T 7/73; G06V 10/26; G06V 10/40; G06V 10/764; G06V 20/70

(52) U.S. Cl. CPC G06V 20/586; G01C 21/3811; G06T 7/73; G06V 10/26; G06V 10/40; G06V 10/764; G06V 20/70; G06T 2207/10028; G06T 2207/20081; G06T 2207/30256; G06T 2207/30264

(57) ABSTRACT

A method for automating target labeling for parking space recognition and an apparatus therefor. A method for generating a three-dimensional (3D) road surface map for parking space recognition includes extracting a semantic feature from a multi-channel image frame received from a wide angle camera to generate an object class masking image, extracting a geometric feature from point cloud data received from light detection and ranging (LiDAR) to generate a ground surface-based point cloud map, and selecting a target label based on the object class masking image and the ground surface-based point cloud map to generate the 3D road surface map for the parking space recognition.

### CROSS-REFERENCE TO RELATED APPLICATION

This application claims the benefit of priority to Korean Patent Application No. 10-2024-0172703, filed in the Korean Intellectual Property Office on Nov. 27, 2024, the entire contents of which are incorporated herein by reference.

### TECHNICAL FIELD

The present disclosure relates to a parking space recognition technology, and more particularly, relates to technologies for automatically generating a target label for parking space recognition using a parking lot three-dimensional (3D) road surface map.

### BACKGROUND

Recently, with the development of vehicle sensor technology, various technologies for ensuring a parking space for parking a vehicle and helping safe and quick parking have been developed.

Each of most vehicles which are currently released is loaded with a parking assist system for recognizing presence of a surrounding vehicle and an obstacle and distances from the surrounding vehicle and the obstacle using its ultrasonic sensor, displaying them on its AVN screen, and notifying a user of risk of collision via a warning alarm.

Furthermore, some large parking facilities may provide a service for displaying whether a parking space is occupied via lighting to allow a driver to check an available parking space.

Recently, a vehicle with a remote smart parking assist system which is useful in a situation in which it is difficult for a driver to ride or alight from a vehicle because a parking space is narrow has been released. The remote smart parking assist system is a system implemented to remotely control parking and exit using a smart key from the outside of the vehicle, which helps to search for a parking space using an ultrasonic sensor and remotely control steering and speed depending on smart key manipulate of a user to perform parking.

However, it is difficult for the existing remote smart parking assist system to be used in a parking space on a ramp, an unpaved road with gravel, or an icy road, a parking space where a tall truck is parked in the periphery or there is a vehicle at one side, an oblique parking space, or the like.

Thus, there is a need for a technology capable of more accurately and safely recognizing a parking space in various parking environments.

Recently, research on a technology for applying image data captured by a camera to a pre-trained model using a deep learning technology and artificial intelligence to recognize an object has been actively conducted.

Deep learning network performance is very influenced by the quality and amount of data. It takes a lot of money and time to construct a large amount of high-quality data.

If a requirement and a function of a deep learning network is changed, changing a structure of a learning model suitable for it is not a big problem, but it takes a lot of cost and time to change existing training data to data suitable for a new requirement. Furthermore, if existing training data is not reused, new training data should be constructed and it also takes a lot of cost and time.

Particularly, in the related art, a person should separately and manually perform labeling for recognition objects to generate a parking lot road surface map.

Thus, there is a need for a parking lot road surface map construction technology for automatically generating a target label capable of quickly and accurately recognizing a parking space from an image captured by a camera, regardless of a parking environment.

### SUMMARY

The present disclosure has been made to solve the above-mentioned problems occurring in the prior art while advantages achieved by the prior art are maintained intact.

An aspect of the present disclosure provides a method for automating target labeling for parking space recognition and an apparatus therefor.

Another aspect of the present disclosure provides a deep learning-based parking lot 3D road surface construction technology for automatically generating a target label for parking space recognition.

Another aspect of the present disclosure provides a method for generating a target label in which it is easy to easily switch to small training data, even if there is a change in a target label requirement for parking space recognition and a label design item, and an apparatus therefor.

Another aspect of the present disclosure provides a method for automating target labeling for parking space recognition to provide a 3D road surface map with a Light Detection and Ranging (LiDAR) real-world coordinate value to map real location information of a target label upon labeling and an apparatus therefor.

Another aspect of the present disclosure provides a method for automating target labeling for parking space recognition to generate a label regardless of a field of view and resolution of an image and selectively generate a label to suit a functional requirement even for an unrecognizable area and an apparatus therefor.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method for generating a three-dimensional (3D) road surface map for parking space recognition may include extracting a semantic feature from a multi-channel image frame received from a wide angle camera to generate an object class masking image, extracting a geometric feature from point cloud data received from light detection and ranging (LiDAR) to generate a ground surface-based point cloud map, and selecting a target label based on the object class masking image and the ground surface-based point cloud map to generate the 3D road surface map for parking space recognition.

As an embodiment, the generating of the object class masking image may include applying the multi-channel image frame to an image recognition segmentation model to generate an initial object class masking image in which a dynamic object is removed and calibrating the initial object class masking image based on a ground surface estimation result value based on the point cloud data which is preprocessed.

As an embodiment, the method may further include estimating host vehicle motion information based on sensor data received from an inertial measurement unit based on electric controller area network with flexible data-rate (IMU based on ECAN FD).

As an embodiment, the sensor data may include at least one of a steering angle, a yaw rate, or a wheel speed.

As an embodiment, a location at which the point cloud data and the multi-channel image frame are logged may be estimated based on the estimated host vehicle motion information.

As an embodiment, the generating of the ground surface-based point cloud map may include accumulating the point cloud data on a time axis based on the estimated host vehicle motion information to generate an initial point cloud map, removing a dynamic object included in the initial point cloud map based on the object class masking image to update the initial point cloud map, and calibrating the updated point cloud map based on height value change information of the point cloud data to generate the ground surface-based point cloud map.

As an embodiment, the target label may include at least one of a parking keypoint, a parking line, or a parking slot.

As an embodiment, the selecting of the target label may be performed via inferring a parking space candidate keypoint for each of a plurality of image frames consecutive for each channel using a parking recognition network, assigning a weight for the inferred candidate keypoint, and determining the candidate keypoint corresponding to a location corresponding to an average value of the assigned weights as the target label.

As an embodiment, the weight may be determined based on at least one of confidence of inference using the parking recognition network, a distance between the inferred candidate keypoint and a camera corresponding to an image frame used for the inference, or a field of view of the candidate keypoint on an image frame corresponding to the inferred candidate keypoint.

As an embodiment, a real-world 3D coordinate value (x, y, z) of the LiDAR, the real-world 3D coordinate value (x, y, z) corresponding to the target label, may be mapped to generate the 3D road surface map.

According to another aspect of the present disclosure, a computing device for generating a three-dimensional (3D) road surface map for parking space recognition may include a processor that executes instructions and a memory storing the instructions. The instructions may be implemented to extract a semantic feature from a multi-channel image frame received from a wide angle camera to generate an object class masking image, extract a geometric feature from point cloud data received from light detection and ranging (LiDAR) to generate a ground surface-based point cloud map, and select a target label based on the object class masking image and the ground surface-based point cloud map to generate the 3D road surface map for parking space recognition.

As an embodiment, the processor may apply the multi-channel image frame to an image recognition segmentation model to generate an initial object class masking image in which a dynamic object is removed and may calibrate the initial object class masking image based on a ground surface estimation result value based on the point cloud data which is preprocessed to generate the object class masking image.

As an embodiment, the processor may estimate host vehicle motion information based on sensor data received from an inertial measurement unit based on electric controller area network with flexible data-rate (IMU based on ECAN FD).

As an embodiment, the sensor data may include at least one of a steering angle, a yaw rate, or a wheel speed.

As an embodiment, the processor may estimate a location at which the point cloud data and the multi-channel image frame are logged based on the estimated host vehicle motion information.

As an embodiment, the processor may accumulate the point cloud data on a time axis based on the estimated host vehicle motion information to generate an initial point cloud map, may remove a dynamic object included in the initial point cloud map based on the object class masking image to update the initial point cloud map, and may calibrate the updated point cloud map based on height value change information of the point cloud data to generate the ground surface-based point cloud map.

As an embodiment, the target label may include at least one of a parking keypoint, a parking line, or a parking slot.

As an embodiment, the processor may infer a parking space candidate keypoint for each of a plurality of image frames consecutive for each channel using a parking recognition network, may assign a weight for the inferred candidate keypoint, and may determine the candidate keypoint corresponding to a location corresponding to an average value of the assigned weights as the target label.

As an embodiment, the weight may be determined based on at least one of confidence of inference using the parking recognition network, a distance between the inferred candidate keypoint and a camera corresponding to an image frame used for the inference, or a field of view of the candidate keypoint on an image frame corresponding to the inferred candidate keypoint.

As an embodiment, the processor may map a real-world 3D coordinate value (x, y, z) of the LiDAR, the real-world 3D coordinate value (x, y, z) corresponding to the target label, to generate the 3D road surface map.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing for describing the entire configuration of a 3D road surface map generation system according to an embodiment of the present disclosure;

FIG. 2 is a block diagram for describing a detailed configuration of a 3D road surface map generation apparatus according to an embodiment of the present disclosure;

FIG. 3 is a block diagram for describing a logical configuration of a 3D road surface map generation apparatus according to an embodiment of the present disclosure;

FIG. 4 is a drawing for describing a configuration and an operation principle of a semantic feature extraction module according to an embodiment of the present disclosure;

FIG. 5 is a drawing for describing a configuration and an operation principle of a geometric feature extraction module according to an embodiment of the present disclosure;

FIG. 6 is a drawing for describing a configuration and an operation principle of a localization and mapping module according to an embodiment of the present disclosure;

FIG. 7 is a drawing for describing a detailed configuration of a localization and mapping module according to an embodiment of the present disclosure;

FIG. 8 is a drawing illustrating a keypoint inference process for automatically generating a target label on a 3D parking road surface map according to an embodiment of the present disclosure;

FIG. 9 is a drawing illustrating a keypoint integration process for automatically generating a target label on a 3D parking road surface map according to an embodiment of the present disclosure;

FIG. 10, FIG. 11, and FIG. 12 are drawings illustrating a keypoint label acquisition process for automatically generating a target label on a 3D parking road surface map according to an embodiment of the present disclosure;

FIG. 13 illustrates a target label type for a parking space according to an embodiment of the present disclosure; and

FIG. 14 illustrates a computing device according to an embodiment of the present disclosure.

### DETAILED DESCRIPTION

Hereinafter, some embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

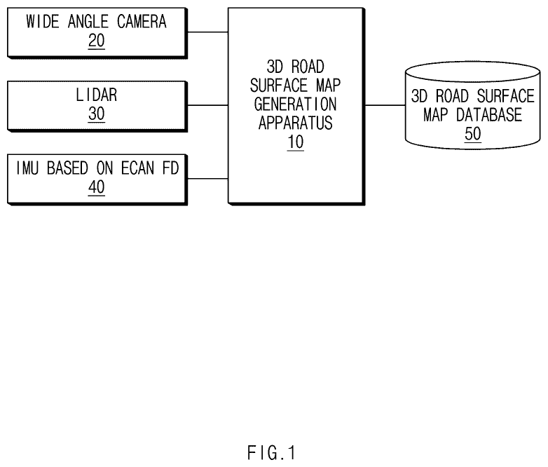

Hereinafter, embodiments of the present disclosure will be described in detail with reference to FIGS. 1 to 14.

FIG. 1 is a drawing for describing the entire configuration of a 3D road surface map generation system according to an embodiment of the present disclosure.

Referring to FIG. 1, a 3D road surface map generation system may be configured to include a 3D road surface map generation apparatus 10, a wide angle camera 20, light detection and ranging (LiDAR) 30, an inertial measurement unit based on electric controller area network with flexible data-rate (IMU based on ECAN FD) 40, and a 3D road surface map database 50.

The wide angle camera 20 may generate a 4-channel wide angle image captured by a 4-front/rear/left/right channel camera sensor of a vehicle and may provide the 3D road surface map generation apparatus 10 with the generated 4-channel wide angle image.

The LiDAR 30 may transmit light (or laser) and may receive the light (or laser) reflected from a surrounding object again to check a position of the object. Raw data may be generated based on the sensing result of the LiDAR 30. The generated raw data may be data in the form of being mixed with noise and a point cloud. Point sampling may be performed to extract meaningful information from the point cloud data and clustering for points may be performed by applying an additional algorithm. The point cloud data may be generated and stored in various formats. As an example, the point cloud data may be generated in the form of at least one of PointXYZI (x, y, z, intensity), PointXYZRGB (x, y, z, RGB), PointXYZRGBA (x, y, z, RGBA), Normal (normal, curvature), or PointNormal (x, y, z, normal, curvature). As described above, the point cloud data may include real-world coordinate information (x, y, z) on a 3D space in common. A close object may be more densely sampled than a distant object in a 3D point cloud obtained by the LiDAR 30. Furthermore, as there is a more distant object, it is easy for a signal reflected from the more distant object to return to have smaller strength and include larger noise. The point cloud obtained via the LiDAR 30 using such properties may include intensity information of reflectance indicating strength of the reflected and returned signal together with 3D coordinates. The information is called intensity.

A position of an object may be displayed via a process of processing the cloud point data, which roughly includes five steps as follows.

Processing: reading raw data stored in a binary (or ASCII) form.

Downsampling: reducing duplicated points among many cloud points included in the raw data to reduce the number of the cloud points.

Segmentation: classifying the downsampled points as a class in a semantic unit. For example, it is divided which point is the ground and which point is the wall.

Clustering: clustering points based on a distance to bind the points in units of a necessary object, if the class is classified via the segmentation task.

Bounding box: displaying a position of an object using a bounding box, if the points are divided for each class and distance via the segmentation and clustering process.

The IMU based on ECAN FD 40 may be composed in a combination of an ECAN FD module and an IMU which measures acceleration, rotation, and the other parameters, but this is only an embodiment. The IMU based on ECAN FD 40 may be implemented such that the ECAN FD module and the IMU are configured as separate components to interwork with each other.

The ECAN FD module may be a module of a 2-port CAN with flexible data-rate (CAN FD) gateway in a Modbus TCP, which may provide Ethernet-based communication based on a Modbus TCP industrial protocol to be easily integrated with an industrial network. The ECAN FD module may provide a plurality of CAN bus interfaces, thus supporting various CAN applications.

The ECAN FD may be used as a data communication protocol for transmitting sensor data and control information between several parts of an electronic system and may have a larger data throughput than a standard CAN currently applied to the vehicle. As an embodiment, the ECAN FD may be used to broadcast sensor data and control information via a two-line interconnection between an electronic instrument and several parts of a control system.

The information collected from the IMU based on ECAN FD 40 may be used to set an initial value of a global position of a parking lot road surface map and estimate motion of a host vehicle to estimate a location on a map in which pieces of sensing data by the wide angle camera 20 and the LiDAR 30 are logged. As an example, sensor data for estimating motion of the host vehicle may include, but is not limited to, at least one of a steering angle, a yaw rate, or a wheel speed.

The 3D road surface map generation apparatus 10 may automatically generate a target label for a parking space based on the 4-channel wide angle image received from the wide angle camera 20, the point cloud data received from the LiDAR 30, and the sensor data received from the IMU based on ECAN FD 40, thus generating a 3D road surface map for parking space recognition.

The 3D road surface map generated by the 3D road surface map generation apparatus 10 may be stored and maintained in the 3D road surface map database 50.

Hereinafter, a description will be given in detail of a detailed configuration and an operation principle of the 3D road surface map generation apparatus 10.

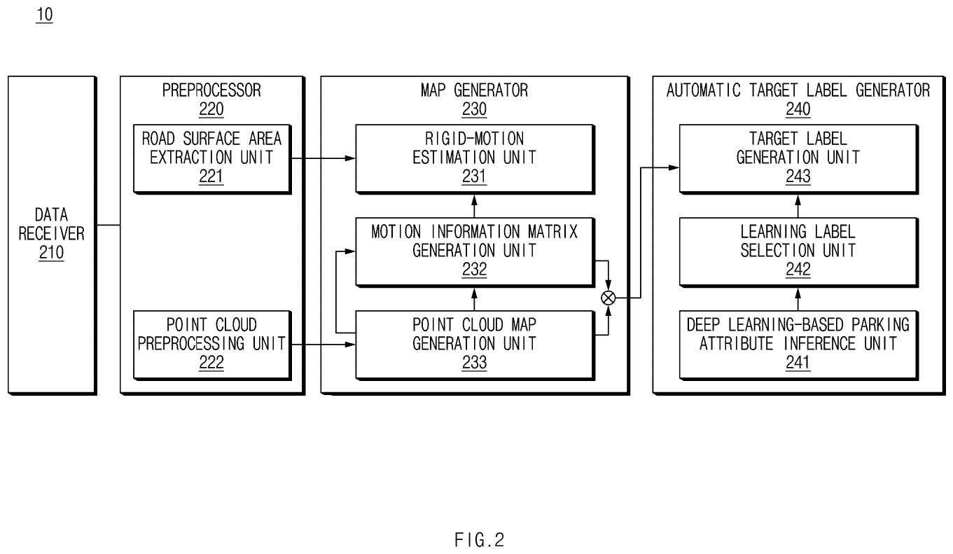

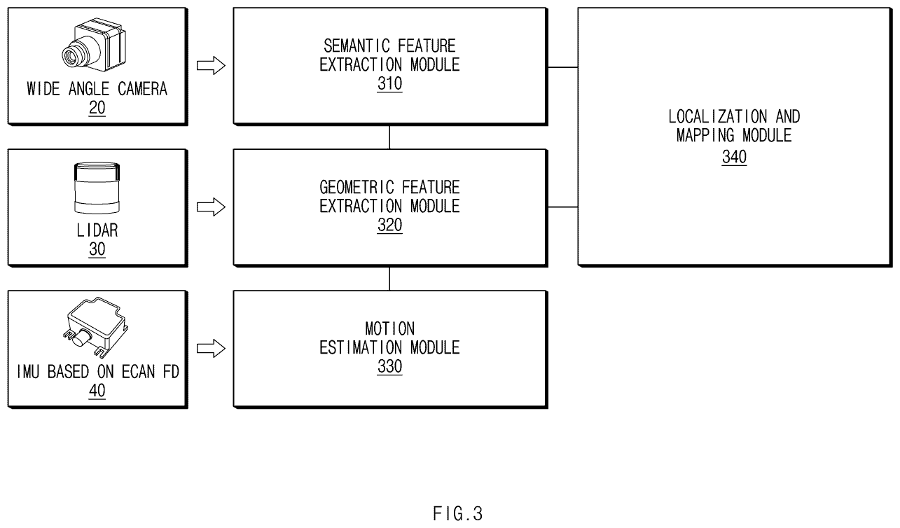

FIG. 2 is a block diagram for describing a detailed configuration of a 3D road surface map generation apparatus according to an embodiment of the present disclosure.

A 3D road surface map generation apparatus 10 may be roughly configured to include a data receiver 210, a preprocessor 220, a map generator 230, and an automatic target label generator 240.

Referring to FIGS. 1 and 2, the data receiver 210 may receive pieces of sensing data from a wide angle camera 20, LiDAR 30, and an IMU based on ECAN FD 40.

The preprocessor 220 may include a road surface area extraction unit 221 and a point cloud preprocessing unit 222.

The road surface area extraction unit 221 may apply a 4-channel wide angle image received from the wide angle camera 20 to a pre-trained image recognition segmentation model to generate an object class masking image. Herein, the road surface area extraction unit 221 may exclude a dynamic object acting on a discouragement to generate a road map and estimate motion information of a host vehicle, for example, a vehicle, a pedestrian, and the like, from masking image extraction and may extract a road surface area including a static object and a fixed object as the object class masking image. Herein, the static object may refer to a road surface-related object including a road, a line, and the like and the fixed object may include a pillar, a fence, a parking stopper, and the like capable of being used as a landmark for loop closure detection or the like if estimating motion information of the host vehicle. Herein, the loop closure detection may be generally a process for identifying a place a robot previously visited, which may help the robot to move again, if the robot loses a trajectory due to motion blur and may control the robot to form a topologically consistent trajectory map.

The output of an image recognition segmentation model may be inaccurate. Particularly, output stability of a road surface area may fail to be large due to a change in road surface state, for example, including a change due to an influence of climate, such as snow or rain, or an influence of ground cover due to fallen leaves and foreign substances.

The point cloud preprocessing unit 222 may perform preprocessing for raw data received from the LiDAR 30. Herein, the preprocessing for the raw data may include at least one of processing, downsampling, segmentation, clustering, or a bounding box, which is described above in FIG. 1.

The point cloud preprocessing unit 222 may use host vehicle motion estimation information to estimate a location on a map in which sensing data by the LiDAR 30 is logged.

The road surface area extraction unit 221 according to an embodiment may further use the preprocessing result of the point cloud preprocessing unit 222 to calibrate a masking image, which is an output value of the image recognition segmentation model, to extract a road surface area. Because it is able to estimate the road surface area based on the degree of change in height value because of the point cloud data includes 3D coordinate information (x, y, z), the point cloud data may be used to perform post-processing calibration of an output error of the image recognition segmentation model.

The map generator 230 may include a rigid-motion estimation unit 231, a motion information matrix generation unit 232, and a point cloud map generation unit 233.

The rigid-motion estimation unit 231 may estimate motion of the host vehicle based on optical flow-based multi-view images. As an embodiment, the rigid-motion estimation unit 231 may determine a disparity between a kth image and a (k+1)th image via optical flow to check a disparity in pixel displacement between two image frames and may estimate motion information from the disparity in pixel displacement via a calibration value of a corresponding camera to perform visual odometry.

The motion information matrix generation unit 232 may generate a matrix for estimating a location of the host vehicle based on host vehicle motion estimation information.

The point cloud map generation unit 233 may generate a ground surface-based point cloud map based on the point cloud preprocessing result.

The point cloud map generation unit 233 according to an embodiment may generate a point cloud map based further on the output value of the image recognition segmentation model.

The motion information matrix generation unit 232 according to an embodiment may generate a motion information matrix based further on the point cloud map generated by the point cloud map generation unit 233.

The automatic target label generator 240 may include a deep learning-based parking attribute inference unit 241, a learning label selection unit 242, and a target label generation unit 243.

The deep learning-based parking attribute inference unit 241 may infer parking attributes from images captured at various locations using a parking space recognition deep learning model and may display the parking attributes on a road surface map of a corresponding parking lot.

The learning label selection unit 242 may extract a parking keypoint candidate group based on the inferred parking attributes and may apply a predefined weight for each parking attribute to the extracted parking keypoint candidate groups to select a learning label.

The target label generation unit 243 may generate a target label using the selected learning label on a parking lot 3D road surface map generated by applying the host vehicle motion information matrix to the ground surface-based point cloud map.

FIG. 3 is a block diagram for describing a logical configuration of a 3D road surface map generation apparatus according to an embodiment of the present disclosure.

Referring to FIG. 3, a 3D road surface map generation apparatus 10 may include a semantic feature extraction module 310, a geometric feature extraction module 320, a motion estimation module 330, and a localization and mapping module 340.

The semantic feature extraction module 310 may output an object class masking image for a 4-channel wide angle image received from a wide angle camera 20. Herein, the object class masking image may be a masking image about a road surface area in a corresponding parking lot, which includes only a static object and a fixed object after a dynamic object is removed.

The semantic feature extraction module 310 may calibrate a masking image using a ground surface estimation result value based on point cloud data of LiDAR 30, which is preprocessed by the geometric feature extraction module 320.

The geometric feature extraction module 320 may generate a point cloud via preprocessing using a host vehicle motion estimation value received from the motion estimation module 330 for raw data received from the LiDAR 30 and may generate a ground surface-based point cloud map using the object class masking image received from the semantic feature extraction module 310.

The motion estimation module 330 may estimate motion of a host vehicle based on sensing data received from an IMU based on ECAN FD 40.

The localization and mapping module 340 may perform optimization for multi-view and multi-temporal samples to generate a 3D road surface map to which the target label is mapped, based on the object class masking image generated by the semantic feature extraction module 310 and the ground surface-based point cloud map generated by the geometric feature extraction module 320.

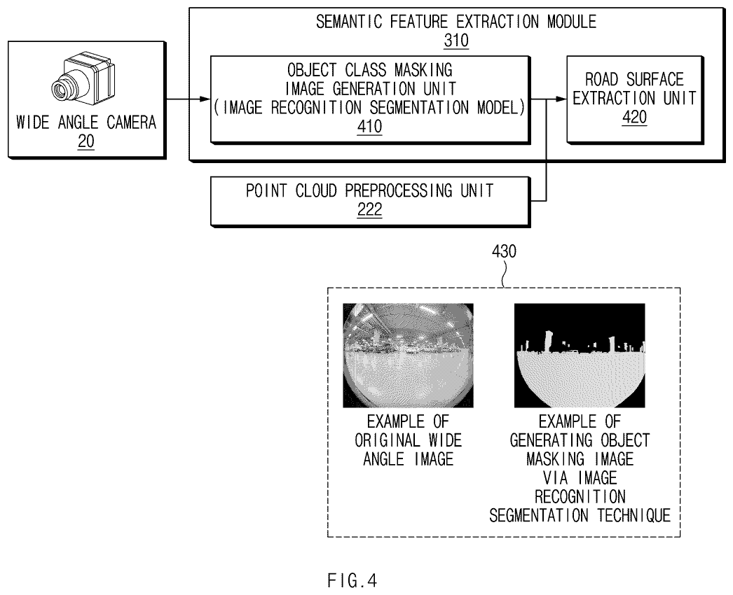

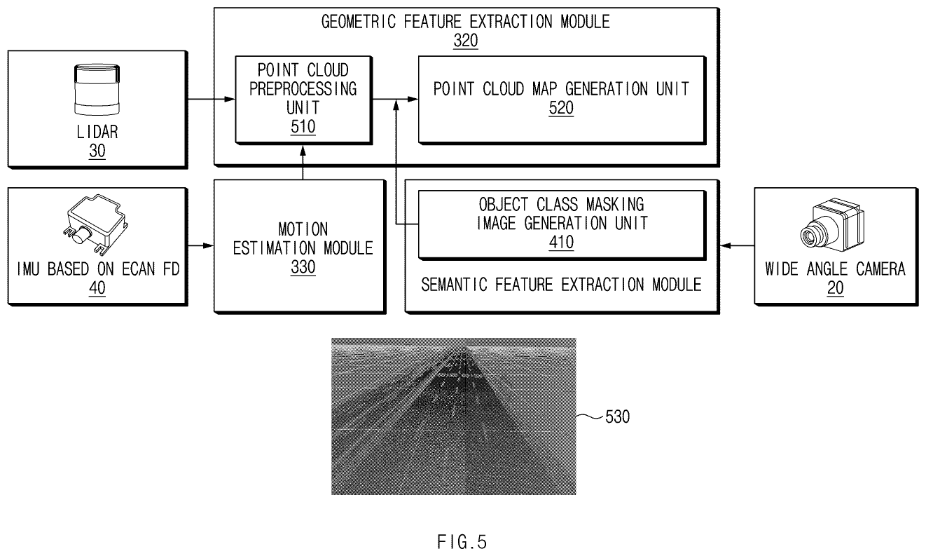

FIG. 4 is a drawing for describing a configuration and an operation principle of a semantic feature extraction module according to an embodiment of the present disclosure.

Referring to FIG. 4, a semantic feature extraction module 310 may include an object class masking image generation unit 410 and a road surface extraction unit 420.

The object class masking image generation unit 410 may apply an original wide angle camera received from a wide angle camera 20 to an image recognition segmentation model to generate an object class masking image as shown in reference numeral 430. Herein, the object class masking image generation unit 410 may exclude a dynamic object acting on a discouragement to generate a road surface map and estimate motion information of a host vehicle, for example, a vehicle, a pedestrian, and the like, from masking image extraction and may extract a road surface area including a static object and a fixed object as the object class masking image. Herein, the static object may refer to a road surface-related object including a road, a line, and the like and the fixed object may include a pillar, a fence, a parking stopper, and the like capable of being used as a landmark for loop closure detection or the like if estimating motion information of the host vehicle.

The road surface extraction unit 420 may calibrate the object class masking image based on preprocessed point cloud data to extract a road surface area.

FIG. 5 is a drawing for describing a configuration and an operation principle of a geometric feature extraction module according to an embodiment of the present disclosure.

Referring to FIG. 5, a geometric feature extraction module 320 may include a point cloud preprocessing unit 510 and a point cloud map generation unit 520.

The point cloud preprocessing unit 510 may perform preprocessing for raw data received from LiDAR 30. Herein, the preprocessing for the raw data may include at least one of processing, downsampling, segmentation, clustering, or a bounding box, which is described above in FIG. 1.

The point cloud preprocessing unit 510 may use host vehicle motion estimation information obtained from a motion estimation module 330 to estimate a location on a map in which sensing data by the LiDAR 30 is logged. Herein, the host vehicle motion estimation information may include sensor values, such as a steering angle, a yaw rate, and a wheel speed, which are obtained from ECAN FD sensors.

As an embodiment, a host vehicle localization value (\tilde{X}ₖ, \tilde{Y}ₖ) corresponding to a kt output value if logging 1st to kth output values of several sensors, for example, a plurality of image frames from a wide angle camera 20, a plurality of LiDAR sweeps, or the like during a specific time may be calculated via the following recursive formula

$$[ \begin{matrix}{\hat{x}}_{k} \\ {\hat{y}}_{k}\end{matrix} ] = [ \begin{matrix}cos ψ & sin ψ \\ - sin ψ & cos ψ\end{matrix} ] ( [ \begin{matrix}{\hat{x}}_{k - 1} - {V}_{x} + Δ {x}_{CoM} \\ {\hat{y}}_{k - 1} - {V}_{y}\end{matrix} ] ) - [ \begin{matrix}Δ {x}_{CoM} \\ 0\end{matrix} ]$$

Herein, Vx and Vy refer to the reference speed on the x-axis and the reference speed on the y-axis, respectively, Ψ refers to the yaw value, and Δ×_{CoM} refers to the host vehicle gravity center value.

The point cloud map generation unit 520 may generate a ground surface-based point cloud map based on preprocessed point cloud data and an object class masking image obtained from an object class masking image generation unit 410.

In detail, the point cloud map generation unit 520 may accumulate point cloud data on a time axis based on estimated host vehicle motion information to generate a 3D parking lot road surface map and may generate a final point cloud-based parking lot road surface map together using the degree of change in LiDAR point height value and the object class masking image.

Because it is difficult to remove a dynamic object by using only the LiDAR point itself due to a lack of appearance information of the LiDAR point, the cloud map generation unit 520 may remove a dynamic object using segmentation masking information obtained from a semantic feature extraction module 310, that is, an object class masking image. Because there may be noise even in the object class masking image depending on various road surface states, the final point cloud-based parking lot road surface map, such as reference numeral 530, may be generated using a height change point of the LiDAR point.

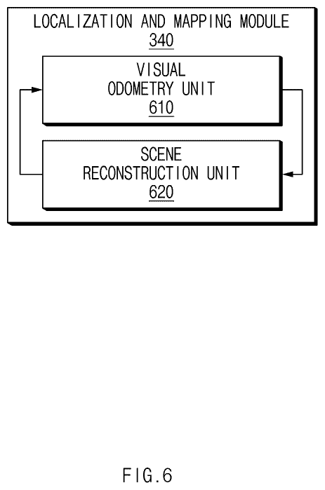

FIG. 6 is a drawing for describing a configuration and an operation principle of a localization and mapping module according to an embodiment of the present disclosure.

Referring to FIG. 6, a localization and mapping module 340 may include a visual odometry unit 610 and a scene reconstruction unit 620.

An initial 3D map may be generated via a geometric feature extraction module 320, but planar odometry via motion information may have a limitation in accuracy.

The visual odometry unit 610 may determine a disparity between a kth image and a (k+1)th image via optical flow to check a disparity in pixel displacement between two image frames and may estimate motion information from the disparity in pixel displacement via a calibration value of a corresponding camera to perform visual odometry.

It is difficult to obtain the only solution, if performing posture estimation via basic visual odometry using only an image captured by a single camera.

It may be possible to perform more sophisticated host vehicle localization, if adding the following constraints to a process.

The visual odometry unit 610 according to an embodiment may interwork with the scene reconstruction unit 620 to perform integrated visual odometry via multi-view camera images captured at the same time point to obtain the only solution and may more accurately perform posture estimation of a host vehicle without a blind spot of a camera.

Furthermore, the visual odometry unit 610 according to an embodiment may interwork with the scene reconstruction unit 620 and may more sophisticatedly estimate coordinates {x, y, z} of the host vehicle on a 3D plane by using a 3D map initially generated using a LiDAR point cloud in addition to localization on a 2D plane via camera calibration.

Furthermore, the visual odometry unit 610 according to an embodiment may interwork with the scene reconstruction unit 620 to calibrate an initial 3D map generated using a host vehicle localization value based on a sensor value obtained from an IMU based on ECAN FD 40 to a location value estimated with visual odometry, thus providing a virtuous cycle structure in which it is possible to generate a more sophisticated 3D map and the sophisticated 3D map provides help to visual odometry-based localization based on an image again. In other words, visual odometry ↔ scene reconstruction may be performed repeatedly N times to facilitate more sophisticated host vehicle localization and thus optimize a 3D map.

As described above, the present disclosure may consider the above-mentioned constraints at the same time for robust visual odometry to provide an end-to-end network structure in which bundle adjustment is able to be performed for multi-view and multi-temporal samples.

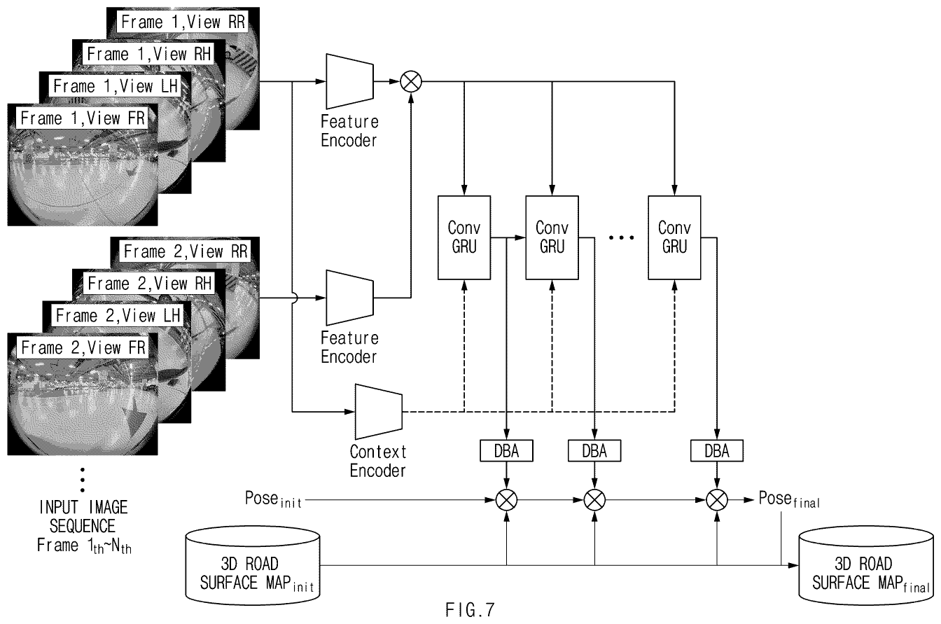

FIG. 7 is a drawing for describing a detailed configuration of a localization and mapping module according to an embodiment of the present disclosure.

In detail, FIG. 7 illustrates logic of a localization and mapping module 340 for estimating a posture (or location) of a host vehicle from a sequentially input multi-view image using a feature encoder, a context encoder, and a multi-stage convolution-gated recurrent unit (GRU) model to generate an optimized 3D road surface map.

The context encoder may be an image learning algorithm unsupervisedly learned via context-based pixel prediction. The feature encoder may be an image learning algorithm implemented to apply feature engineering to improve performance with better prediction while proceeding with machine learning and learn various and many features, that is, an independent variable depending on a predefined semantic/geometric feature.

The convolution-GRU applied according to an embodiment of the present disclosure may have a gate structure to be similar to an existing long short term memory (LSTM). However, the LSTM may be composed of a forget gate, an input gate, and an output gate, whereas the convolution-GRU may be composed of an update gate into which a reset gate and the forget gate and the input gate of the LSTM combine may have a characteristic in which a cell state and a hidden state of the LSTM are integrated into the hidden state. Herein, the reset gate may determine how much the past information should be forgotten. The update gate may determine whether to reflect a previous state and a current state at any rate.

The convolution-GRU may learn temporal dependency in a dataset. In addition, the convolution-GRU may have a smaller block architecture than the LSTM and may show similar or better performance than the existing LSTM without the necessity of an additional algorithm for supporting a model.

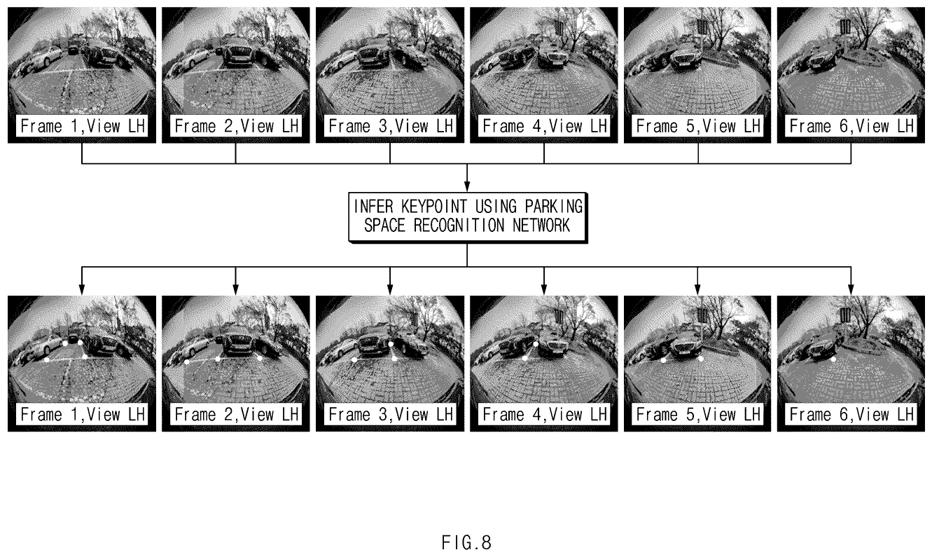

FIG. 8 is a drawing illustrating a keypoint inference process for automatically generating a target label on a 3D parking road surface map according to an embodiment of the present disclosure.

As shown in FIG. 8, a 3D road surface map generation apparatus 10 according to the present disclosure may infer a parking space keypoint on each image frame sequentially input using a parking space recognition network.

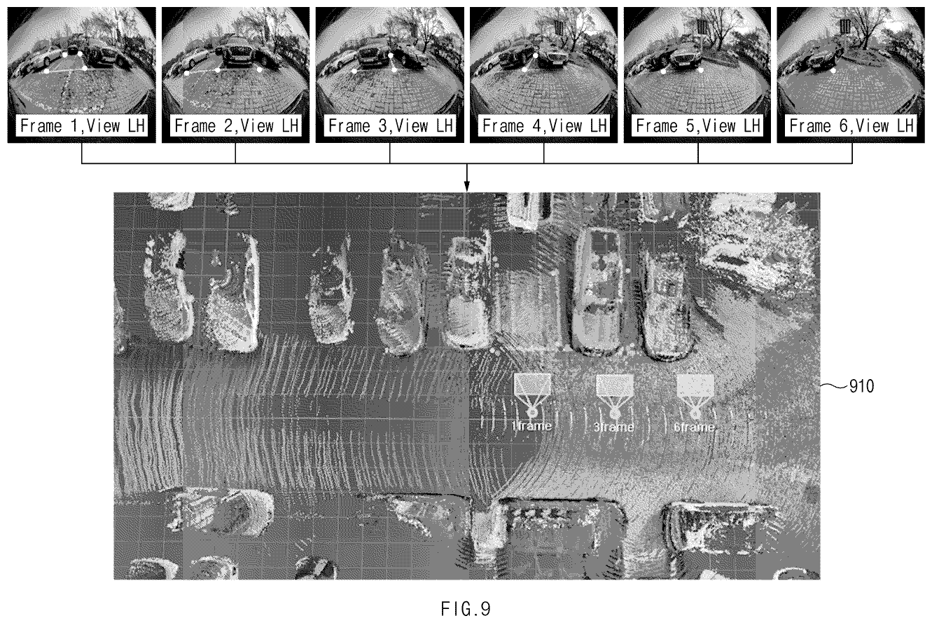

FIG. 9 is a drawing illustrating a keypoint integration process for automatically generating a target label on a 3D parking road surface map according to an embodiment of the present disclosure.

As shown in FIG. 9, a 3D road surface map generation apparatus 10 may calibrate all keypoints primarily inferred for each image frame using a calibration parameter and may collectively project and reflect the calibrated keypoints in a 3D parking road surface map as shown in reference numeral 910.

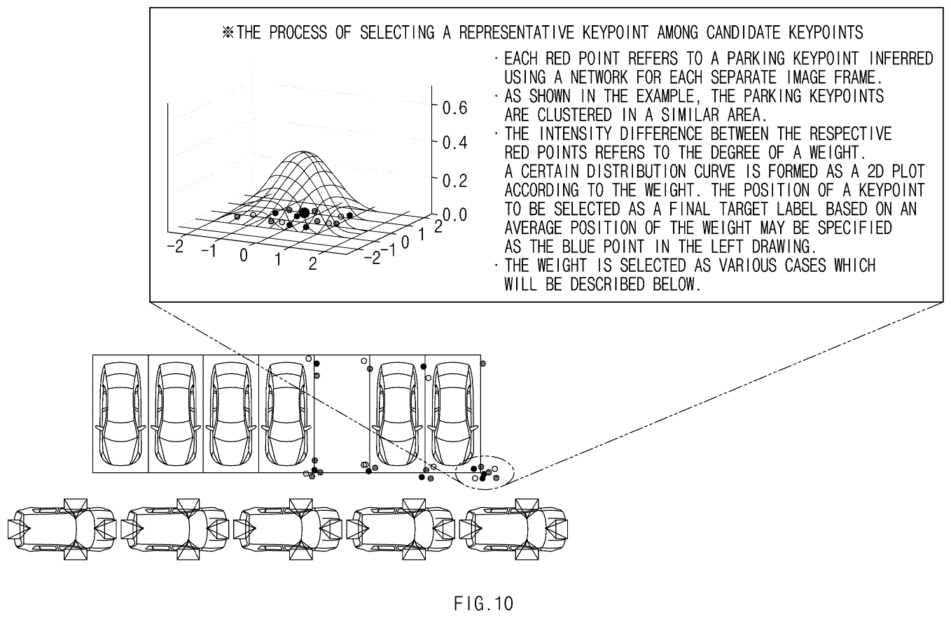

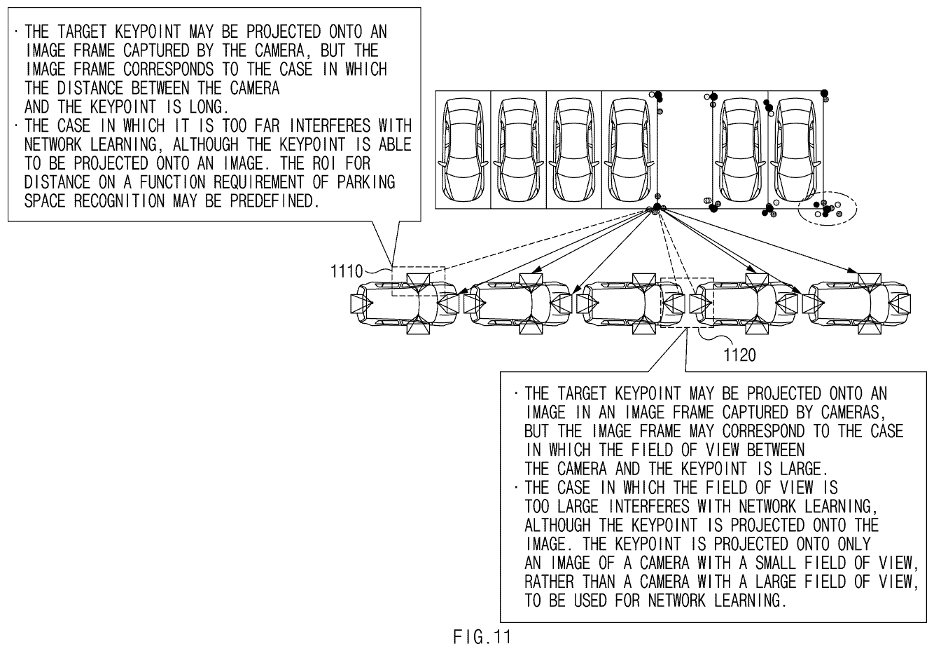

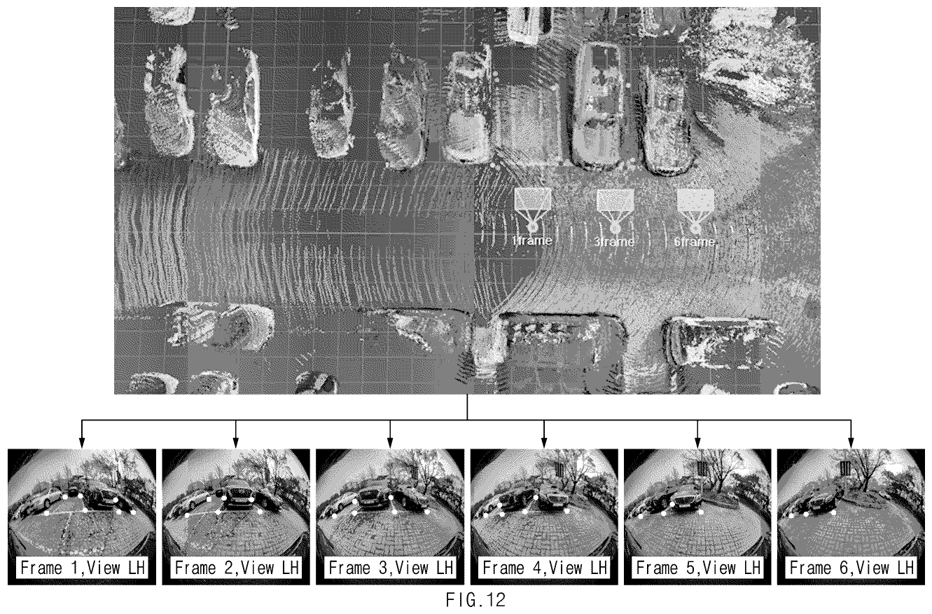

FIGS. 10 to 12 are drawings illustrating a keypoint label acquisition process for automatically generating a target label on a 3D parking road surface map according to an embodiment of the present disclosure.

In detail, FIG. 10 illustrates a process of selecting a representative keypoint among inferred candidate keypoints.

Referring to FIG. 10, each red point refers to a parking keypoint inferred using a machine learning network for each separate image frame.

As shown in the example, the inferred parking keypoints may be clustered in a similar area. An intensity difference between the respective red points refers to a degree of a weight. A certain distribution curve may be formed as a 2D plot according to a weight. A position of a keypoint to be selected as a final target label based on an average position of the weight may be specified as a blue point in the left drawing. Herein, the weight for the candidate keypoint may be selected as various cases which will be described below.

It may be possible to assign a weight using inference confidence (or a probability value) of network inference.

Because a distance between the inferred keypoint and a camera corresponding to the image frame used for the inference varies, it may be possible to assign a weight according to the distance using a characteristic in which the accuracy of inference varies with the distance.

As the accuracy of inference according to distortion of an image is lower as the keypoint leans towards the outside, not the front, that is, a camera reference orientation angle is larger, on an image frame depending on a distortion degree of a wide angle image, it may be possible to assign a larger weight as a field of view of the keypoint is smaller on the image frame.

FIG. 11 illustrates a procedure for projecting a keypoint, which is a target label on a 3D road surface, onto a plurality of image frames to generate a keypoint label. In detail, FIG. 11 illustrates a process of selecting a specific target keypoint to project the specific target keypoint onto a plurality of image frames.

In FIG. 11, an image frame captured by a camera, which is displayed in red and blue dotted lines, may be excluded from target keypoint projection and an image frame captured by a camera, which is displayed in black sold line, may be used for the target keypoint projection.

Referring to FIG. 11, the target keypoint may be projected onto an image frame captured by a camera in reference numeral 1110, but the image frame may correspond to the case in which a distance between the camera and the keypoint is long. The case in which it is too far interferes with network learning, although the keypoint is able to be projected onto an image. If return on investment (ROI) for distance on a function requirement of parking space recognition is predefined, the image frame captured by the camera may be excluded from keypoint projection.

A target keypoint may be projected onto an image in an image frame captured by cameras in reference numeral 1120, but the image frame may correspond to the case in which a field of view between the camera and the keypoint is large. The case in which the field of view is too large may interfere with network learning, although the keypoint is projected onto the image. The keypoint may be projected onto only an image of a camera with a small field of view, rather than a camera with a large field of view, to be used for network learning.

FIG. 12 illustrates an example of the result of mapping N target keypoints projected onto a 3D parking road surface map to M image frames in a valid range.

As described above, if the 3D road surface map for parking space recognition is constructed via accurate localization using the technique proposed in the present disclosure, it is able to automatically generate the target label of the image. Compared to seeing an existing image and manually generating a label, it may considerably reduce the cost of constructing training data.

Because a manual task is minimized in a target label generation scheme via the method proposed in the present disclosure, it is easy to respond to various edge-cases and it is easy to easily switch to small training data, although there is a change in target label requirement and label design item.

Furthermore, because a 3D road surface map generated according to the proposed method of the present disclosure has a LiDAR real-world coordinate value (x, y, z), it may provide real location information of a target label, if performing labeling via the proposed methodology.

Furthermore, a scheme which manually generating a target label using only an existing image degrades quality of a parking space label due to a limited field of view (e.g., occlusion by an object) and resolution (e.g., deterioration in long distance resolution). Particularly, an existing scheme generates and learns an unrecognizable area using separate label attributes (e.g., an unknown, invisible, and background type class). This has an influence on decrease in model performance or constrains the functional elements of the model. On the other hand, the present disclosure is able to generate a label, regardless of a field of view and resolution of an image, if generating the label via a 3D parking lot road surface map, it is possible to selectively generate the label to suit a functional requirement even for the unrecognizable area.

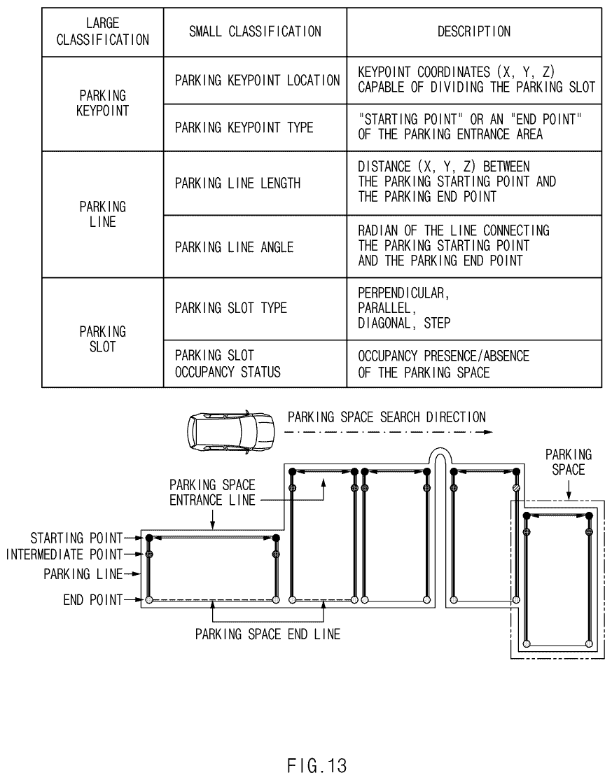

FIG. 13 illustrates a target label type for a parking space according to an embodiment of the present disclosure.

The above description of FIGS. 1 to 12 is given of the example of generating the target label around a parking point (represented as a parking keypoint or a keypoint), and this is only for the convenience of description. It should be noted that a parking line and a parking slot are also used as a target label for a parking space like a table shown in FIG. 13.

The parking keypoint may be defined as a parking keypoint location indicating keypoint coordinates (X, Y, Z) capable of dividing the parking slot and a parking keypoint type for identifying whether the keypoint coordinates are a “starting point” or an “end point” of a parking entrance area.

The parking line may be defined as a parking line length indicating a distance between a parking starting point and a parking end point and a parking line angle indicating a radian of a line connecting the parking starting point and the parking end point.

The parking slot may be defined as a parking slot type for identifying whether the shape of the parking space is perpendicular, parallel, diagonal, or step and a parking slot occupancy state for identifying an occupancy state (presence/absence) of the parking space.

It should be noted that the type of the target label for the above-mentioned parking space is able to be differently applied according to the design and the function requirement of those skilled in the art for the parking space recognition method.

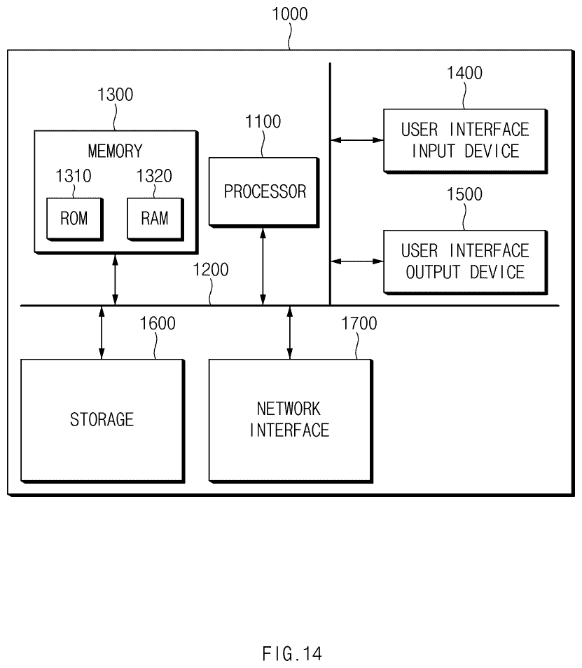

FIG. 14 illustrates a computing device according to an embodiment of the present disclosure.

Referring to FIG. 14, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM. For example, the processor 1100 may be mounted on the 3D road surface map generation apparatus 10 described above.

The exemplary storage medium may be coupled to the processor 1100. The processor 1100 may read out information from the storage medium and may write information in the storage medium. Alternatively, the storage medium may be integrated with the processor 1100. The processor 1100 and storage medium may be implemented with an application specific integrated circuit (ASIC). The ASIC may reside on the 3D road surface map generation apparatus 10.

The present technology may provide the method for automating the target labeling for the parking space recognition and the apparatus therefor.

Furthermore, the present technology may provide a deep learning-based parking lot 3D road surface construction technology for automatically generating a target label for parking space recognition to reduce the cost of constructing training data.

Furthermore, the present technology may provide the method for generating the target label in which it is easy to easily switch to small training data, even if there is a change in a target label requirement for parking space recognition and a label design item and it is easy to respond to various edge-cases and the apparatus therefor.

Furthermore, the present technology may provide the method for automating the target labeling for the parking space recognition to provide a 3D road surface map with a LiDAR real-world coordinate value to map real location information of a target label upon labeling and the apparatus therefor.

Furthermore, the present technology may provide the method for automating the target labeling for the parking space recognition to generate a label regardless of a field of view and resolution of an image and selectively generate a label to suit a functional requirement even for an unrecognizable area to ensure quality of a parking space label and the apparatus therefor.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Accordingly, embodiments of the present disclosure are intended not to limit but to explain the technical idea of the present disclosure, and the scope and spirit of the invention is not limited by the above embodiments. The scope of the present disclosure should be construed on the basis of the accompanying claims, and all the technical ideas within the scope equivalent to the claims should be included in the scope of the present disclosure.

What is claimed is:

1. A computing device for generating a three-dimensional (3D) road surface map, the computing device comprising:
a processor configured to execute instructions; and
a memory storing the instructions,
wherein the instructions are implemented to:
extract a semantic feature from a multi-channel image frame received from a wide angle camera to generate an object class masking image;
extract a geometric feature from point cloud data received from light detection and ranging (LiDAR) to generate a ground surface-based point cloud map; and
select a target label based on the object class masking image and the ground surface-based point cloud map to generate the 3D road surface map for parking space recognition.

2. The computing device of claim 1, wherein the processor is further configured to:
apply the multi-channel image frame to an image recognition segmentation model to generate an initial object class masking image in which a dynamic object is removed; and
calibrate the initial object class masking image based on a ground surface estimation result value based on the point cloud data which is preprocessed to generate the object class masking image.

3. The computing device of claim 1, wherein the processor is further configured to:
estimate host vehicle motion information based on sensor data received from an inertial measurement unit based on electric controller area network with flexible data-rate (IMU based on ECAN FD).

4. The computing device of claim 3, wherein the sensor data includes at least one of a steering angle, a yaw rate, or a wheel speed.

5. The computing device of claim 3, wherein the processor is further configured to:
estimate a location at which the point cloud data and the multi-channel image frame are logged based on the estimated host vehicle motion information.

6. The computing device of claim 3, wherein the processor is further configured to:
accumulate the point cloud data on a time axis based on the estimated host vehicle motion information to generate an initial point cloud map;
remove a dynamic object included in the initial point cloud map based on the object class masking image to update the initial point cloud map; and
calibrate the updated point cloud map based on height value change information of the point cloud data to generate the ground surface-based point cloud map.

7. The computing device of claim 1, wherein the target label includes at least one of a parking keypoint, a parking line, or a parking slot.

8. The computing device of claim 1, wherein the processor is further configured to:
infer a parking space candidate keypoint for each of a plurality of image frames consecutive for each channel using a parking recognition network;
assign a weight for the inferred candidate keypoint; and
determine the candidate keypoint corresponding to a location corresponding to an average value of the assigned weights as the target label.

9. The computing device of claim 8, wherein the weight is determined based on at least one of:
confidence of inference using the parking recognition network;
a distance between the inferred candidate keypoint and a camera corresponding to an image frame used for the inference; or
a field of view of the candidate keypoint on an image frame corresponding to the inferred candidate keypoint.

10. The computing device of claim 1, wherein the processor is further configured to:
map a real-world 3D coordinate value (x, y, z) of the LiDAR, the real-world 3D coordinate value (x, y, z) corresponding to the target label, to generate the 3D road surface map.

11. A method for generating a three-dimensional (3D) road surface map, the method comprising:
extracting a semantic feature from a multi-channel image frame received from a wide angle camera to generate an object class masking image;
extracting a geometric feature from point cloud data received from light detection and ranging (LiDAR) to generate a ground surface-based point cloud map; and
selecting a target label based on the object class masking image and the ground surface-based point cloud map to generate the 3D road surface map for parking space recognition.

12. The method of claim 11, wherein the generating of the object class masking image includes:
applying the multi-channel image frame to an image recognition segmentation model to generate an initial object class masking image in which a dynamic object is removed; and
calibrating the initial object class masking image based on a ground surface estimation result value based on the point cloud data which is preprocessed.

13. The method of claim 11, further comprising:
estimating host vehicle motion information based on sensor data received from an inertial measurement unit based on electric controller area network with flexible data-rate (IMU based on ECAN FD).

14. The method of claim 13, wherein the sensor data includes at least one of a steering angle, a yaw rate, or a wheel speed.

15. The method of claim 13, wherein a location at which the point cloud data and the multi-channel image frame are logged is estimated based on the estimated host vehicle motion information.

16. The method of claim 13, wherein the generating of the ground surface-based point cloud map includes:
accumulating the point cloud data on a time axis based on the estimated host vehicle motion information to generate an initial point cloud map;
removing a dynamic object included in the initial point cloud map based on the object class masking image to update the initial point cloud map; and
calibrating the updated point cloud map based on height value change information of the point cloud data to generate the ground surface-based point cloud map.

17. The method of claim 11, wherein the target label includes at least one of a parking keypoint, a parking line, or a parking slot.

18. The method of claim 11, wherein the selecting of the target label is performed via:
inferring a parking space candidate keypoint for each of a plurality of image frames consecutive for each channel using a parking recognition network;
assigning a weight for the inferred candidate keypoint; and
determining the candidate keypoint corresponding to a location corresponding to an average value of the assigned weights as the target label.

19. The method of claim 18, wherein the weight is determined based on at least one of:
confidence of inference using the parking recognition network;
a distance between the inferred candidate keypoint and a camera corresponding to an image frame used for the inference; or
a field of view of the candidate keypoint on an image frame corresponding to the inferred candidate keypoint.

20. The method of claim 11, wherein a real-world 3D coordinate value (x, y, z) of the LiDAR, the real-world 3D coordinate value (x, y, z) corresponding to the target label, is mapped to generate the 3D road surface map.
